(19) United States
(12) Patent Application Publication
(10) Pub. No.: US 2026/0252413 A1
(43) Pub. Date: Aug. 27, 2026

(54) BIDIRECTIONAL COMMUNICATION METHOD, APPARATUS AND DEVICE, AND MEDIUM

(71) Applicant: BEIJING BYTEDANCE NETWORK TECHNOLOGY CO., LTD., Beijing (CN)

(72) Inventors: Meng HUANG, Beijing (CN); Qingying ZHU, Beijing (CN); Xinqi XIE, Beijing (CN)

(21) Appl. No.: 18/714,061

(22) PCT Filed: Nov. 21, 2022
(86) PCT No.: PCT/CN2022/133223

§ 371 Date: May 28, 2024

(30) Foreign Application Priority Data
Nov. 25, 2021 (CN) 202111413623.8

(51) Int. Cl. G06F 9/54

(52) U.S. Cl. CPC G06F 9/54

(57) ABSTRACT

The present invention relates to a bidirectional communication method, apparatus and device, and a medium, which are used for implementing real-time communication between processes, so as to improve the efficiency of communication and save system resources. The method comprises: after it is determined that a first process is about to communicate with a second process, adding an identifier corresponding to the first process and an identifier corresponding to the second process into a periodic table; on the basis of a bidirectional communication process, enabling the first process to communicate with the second process; and when it is determined that any process stops bidirectional communication, deleting the identifier corresponding to the process from the periodic table.

### CROSS-REFERENCE TO RELATED APPLICATIONS

This application is a U.S. National Stage under 35 U.S.C. § 371 of International Application No. PCT/CN 2022/133223, as filed on Nov. 21, 2022, which is based on and claims priority to Chinese Patent Application No. 202111413623.8, filed on Nov. 25, 2021 and entitled “BIDIRECTIONAL COMMUNICATION METHOD, APPARATUS AND DEVICE, AND MEDIUM”, and the entire contents of each of these applications which are incorporated herein by reference.

### TECHNICAL FIELD

The present disclosure relates to the field of computer technologies, and in particular, to a two-way communication method, apparatus, and device, and a medium.

### BACKGROUND ART

Android is a free and open source operating system based on a Linux kernel. It is mainly used on a mobile device, such as a smart phone and a tablet computer. There are many inter-component communication methods in Android application development, such as Start Activity For Result, ViewModel, and EventBus. Start Activity For Result is a cross-page communication method natively supported by the Android system.

### SUMMARY OF THE INVENTION

The present disclosure provides a two-way communication method, apparatus, and device, and a medium.

According to a first aspect, an embodiment of the present disclosure provides a two-way communication method. The method includes: adding an identifier corresponding to the first process and another identifier corresponding to the second process to a lifecycle table, in response to determining that a first process is to communicate with a second process; causing the first process to communicate with the second process based on a two-way communication process; and deleting the identifier corresponding to either of the processes from the lifecycle table when it is determined that the process stops communicating.

In a possible implementation, the method provided in this embodiment of the present disclosure further includes: adding an identifier corresponding to a third process to the lifecycle table when it is determined that the third process is to communicate with a target process corresponding to any one of identifiers in the lifecycle table; and causing the third process to communicate with the target process based on the two-way communication process.

In a possible implementation, the method provided in this embodiment of the present disclosure further includes: stopping the two-way communication process when there is no identifier corresponding to a process in the lifecycle table.

In a possible implementation, after the two-way communication process is stopped, the method provided in this embodiment of the present disclosure further includes: deleting the two-way communication process and the lifecycle table.

In a possible implementation, in the method provided in this embodiment of the present disclosure, the two-way communication process is generated within a shared region.

According to a second aspect, an embodiment of the present disclosure provides a two-way communication apparatus. The apparatus includes: an addition unit configured to add an identifier corresponding to the first process and another identifier corresponding to the second process to a lifecycle table in response to determining that a first process is to communicate with a second process; a communication unit configured to cause the first process to communicate with the second process based on a two-way communication process; and a deletion unit configured to delete the identifier corresponding to either of the processes from the lifecycle table when it is determined that the process stops communicating.

In a possible implementation, in the apparatus provided in this embodiment of the present disclosure, the addition unit is further configured to add an identifier corresponding to a third process to the lifecycle table when it is determined that the third process is to communicate with a target process corresponding to any one of identifiers in the lifecycle table; and the communication unit is further configured to cause the third process to communicate with the target process based on the two-way communication process.

In a possible implementation, in the apparatus provided in this embodiment of the present disclosure, the communication unit is further configured to stop the two-way communication process when there is no identifier corresponding to a process in the lifecycle table.

In a possible implementation, in the apparatus provided in this embodiment of the present disclosure, the deletion unit is further configured to delete the two-way communication process and the lifecycle table.

In a possible implementation, in the apparatus provided in this embodiment of the present disclosure, the two-way communication process is generated within a shared region.

According to a third aspect, an embodiment of the present disclosure provides a two-way communication device. The device includes: a memory; a processor; and a computer program, where the computer program is stored in the memory, and is configured to be executed by the processor to cause the method according to the first aspect to be implemented.

According to a fourth aspect, an embodiment of the present disclosure provides a computer-readable storage medium having stored thereon a computer program that, when executed by a processor, causes the method according to the first aspect to be implemented.

According to a fifth aspect, an embodiment of the present disclosure provides a computer program product, including a computer program/instructions that, when executed by a processor, implements/implement the two-way communication method described above.

According to a sixth aspect, an embodiment of the present disclosure further provides a computer program, including instructions that, when executed by a processor, implement the two-way communication method described above.

### BRIEF DESCRIPTION OF DRAWINGS

The accompanying drawings herein, which are incorporated into and form a part of the description, illustrate the embodiments in line with the present disclosure and are used in conjunction with the description to explain a principle of the present disclosure.

To describe technical solutions in the embodiments of the present disclosure or in the prior art more clearly, the accompanying drawings to be used for description of the embodiments or the prior art will be briefly described below. Apparently, those of ordinary skill in the art may derive other drawings from these accompanying drawings without any creative effort.

FIG. 1 is a schematic diagram of an MVVM method according to the Background Art of the present disclosure;

FIG. 2 is a schematic flowchart of a two-way communication method according to an embodiment of the present disclosure;

FIG. 3 is a schematic flowchart of a two-way communication method according to an embodiment of the present disclosure;

FIG. 4 is a schematic flowchart of another two-way communication method according to an embodiment of the present disclosure;

FIG. 5 is a schematic diagram of a code structure according to an embodiment of the present disclosure;

FIG. 6 is a schematic diagram of a calling process method according to an embodiment of the present disclosure;

FIG. 7 is a schematic diagram of an MVVM method according to an embodiment of the present disclosure;

FIG. 8 is a schematic diagram of a structure of a two-way communication apparatus according to an embodiment of the present disclosure; and

FIG. 9 is a schematic diagram of a structure of an electronic device according to an embodiment of the present disclosure.

### DETAILED DESCRIPTION OF THE INVENTION

For a clearer understanding of the foregoing objectives, features, and advantages of the present disclosure, the solutions of the present disclosure will be further described below. It should be noted that the embodiments in the present disclosure and features in the embodiments can be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

Some of the terms herein are explained below.

The term “and/or” in the embodiments of the present disclosure describes an association relationship between associated objects, and indicates that three relationships may exist, for example, A and/or B may indicate that: only A exists, both A and B exist, and only B exists. The character “/” generally indicates an “or” relationship between the associated objects.

Android: a free and open source operating system based on a Linux kernel, and is mainly used on a mobile device.

EventBus: a lightweight Android event publish/subscribe framework, which can replace conventional Android Intent, Handler, Broadcast, or interface functions, for data transfer and method execution between threads in a Fragment, an Activity, and a Service.

ViewModel: Model-View-ViewModel (MVVM). It is essentially an improved version of Model-View-Controller (MVC). The MVVM is to abstract a state and behavior of a View therein, and an MVVM framework is a new architectural framework that has evolved from the application of a Model-View-Presenter (MVP) pattern combined with WPF. It is based on the original MVP framework and incorporates new features of the WPF to cope with increasingly complex changes in customer requirements.

Start Activity For Result: a cross-page communication method natively supported by the Android system, which has the advantages of being simple and easy to use, but does not support real-time communication.

It is simple and easy to use, but it can only support communication between two neighboring open Activities and does not support real-time communication. ViewModel supports two-way real-time communication between components in one Activity, but does not support communication between components across multiple Activities. EventBus supports real-time communication between components across multiple Activities, but it requires a developer to ensure, when coding, that a subscription is canceled at the end of a lifecycle of an Activity, which is cumbersome to implement, and results in a high degree of coupling in coding.

Therefore, there is an urgent need to provide simple cross-page real-time communication, to overcome the problems of the above existing components.

The two-way communication method, apparatus, and device, and a medium detect information from a sender and a receiver in real time, thereby improving code compilation efficiency.

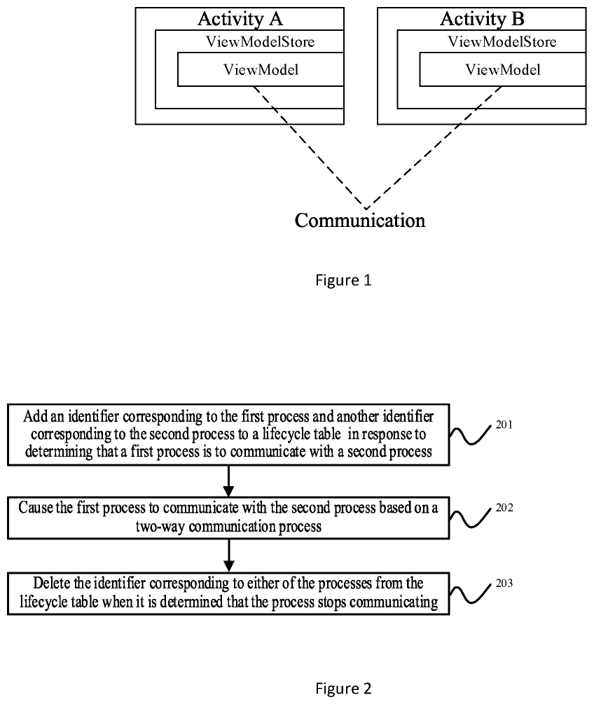

Android is a free and open source operating system based on a Linux kernel. It is mainly used on a mobile device, such as a smart phone and a tablet computer. There are many inter-component communication methods in Android application development, such as Start Activity For Result, ViewModel, and EventBus. Start Activity For Result is a cross-page communication method natively supported by the Android system. It is simple and easy to use, but it can only support communication between two neighboring open Activities and does not support real-time communication. As shown in FIG. 1, ViewModel supports two-way real-time communication between components in an Activity, but does not support communication between components across multiple Activities. EventBus supports real-time communication between components across multiple Activities, but it requires a developer to ensure, when coding, that a subscription is canceled at the end of a lifecycle of an Activity, which is cumbersome to implement, and results in high degree of coupling in coding.

The two-way communication solution provided in the embodiments of the present disclosure uses ViewModel under AndroidX, which has an original capability to support inter-component communication. For real-time communication between multiple components, ViewModel under AndroidX that can support inter-component communication with its original capability is used. However, since the ViewModel is generally stored in a ViewModelStore, and the ViewModelStore is saved in an Activity or a Fragment, the ViewModel has a same lifecycle as the Activity or the Fragment where the ViewModel is saved.

FIG. 2 shows a two-way communication method according to an embodiment of the present disclosure. The method includes the following steps.

S201: Add an identifier corresponding to the first process and another identifier corresponding to the second process to a lifecycle table in response to determining that a first process is to communicate with a second process.

During specific implementation, when the first process is to communicate with the second process, the identifier corresponding to the first process and the identifier corresponding to the second process are separately added to the lifecycle table. Certainly, when it is determined that another process is to communicate with a process having a corresponding identifier existing in the lifecycle table, an identifier of the another process is added to the lifecycle table.

S202: Cause the first process to communicate with the second process based on a two-way communication process.

During specific implementation, after the identifier corresponding to the first process and the identifier corresponding to the second process are added in step S201, that is, after the identifier of the first process and the identifier of the second process exist in the lifecycle table, the first process is caused to communicate with the second process. Certainly, if a third process needs to communicate with the first process, after an identifier corresponding to the third process exists in the lifecycle table, the first process is caused to communicate with the third process.

It should be noted that if the third process communicates with the first process while the first process is communicating with the second process, in this case, the second process and the third process may communicate with each other directly or indirectly via the first process, or the second process and the third process may be caused not to communicate with each other, which is not limited in this embodiment of the present disclosure.

S203: Delete the identifier corresponding to either of the processes from the lifecycle table when it is determined that the process stops communicating.

During specific implementation, when it is determined that either of the processes stops using two-way communication, the identifier corresponding to the process is deleted from the lifecycle table, and when there is no identifier corresponding to a process in the lifecycle table, the two-way communication process is stopped, and the two-way communication process and the lifecycle table are deleted. In this way, memory can be cleared when the two-way communication is not needed, which saves system resources.

In the two-way communication method provided in this embodiment of the present disclosure, when it is determined that the first process communicates with the second process, the identifier corresponding to the first process and the identifier corresponding to the second process are separately added to the lifecycle table, then the first process is caused to communicate with the second process, and when either of the processes stops using the two-way communication, the identifier corresponding to the process is deleted from the lifecycle table. Real-time communication between processes is achieved, communication efficiency is improved, and system resources are saved.

In the two-way communication method provided in this embodiment of the present disclosure, in response to determining that a first process is to communicate with a second process, the identifier corresponding to the third process is added to the lifecycle table, which achieves the real-time communication between the multiple processes and improves the communication efficiency.

In the two-way communication method provided in this embodiment of the present disclosure, the two-way communication process is generated within a shared region and is not affected by a lifecycle of the process, which improves the communication efficiency.

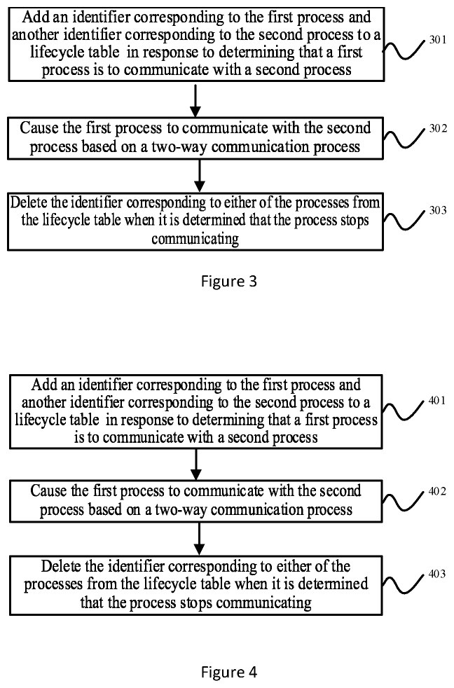

Specifically, an embodiment of the present disclosure is described in detail by taking FIG. 3 and FIG. 4 as an example.

FIG. 3 is a two-way communication method according to an embodiment of the present disclosure. The method includes the following steps.

S301: Add, an identifier corresponding to the first process and another identifier corresponding to the second process to a lifecycle table in response to determining that a first process is to communicate with a second process.

During specific implementation, first, a ClearUseless ViewModelObserver is customized and a LifecycleEventObserver interface is implemented. A Lifecycle object and a Map object are passed to the ClearUseless ViewModelObserver, and then an onStateChanged method of the LifecycleEventObserver interface is implemented. When a parameter LifecycelEvent is Event. DESTROYED, this method removes a previous lifecycle from a corresponding value of the Map.

Once the above preparations are completed, a process name of the first process and a process name of the second process are added to the Lifecycle.

S302: Cause the first process to communicate with the second process based on a two-way communication process.

During implementation, when it is detected that the Lifecycle contains the process name of the first process and the process name of the second process, the first process is caused to perform communication with the second process using ViewModel.

S303: Delete the identifier corresponding to either of the processes from the lifecycle table when it is determined that the process stops communicating.

During specific implementation, when the process stops communication using the ViewModel, the process name of the process is deleted from the Lifecycle.

Using the two-way communication method provided in this embodiment can cause the processes to communicate with each other using the ViewModel, and based on the lifecycle table, it is ensured that after the processes stop communicating with each other and cause the ViewModel to be closed, information of the processes is still retained. When other processes communicate, they can directly communicate with each other after enabling a new ViewModel. However, this solution requires opening and closing the ViewModel for several times, which is not conducive to specific implementation. Therefore, as shown in FIG. 4, an embodiment of the present disclosure provides another two-way communication method. The method includes the following specific steps.

S401: Add, an identifier corresponding to the first process and another identifier corresponding to the second process to a lifecycle table in response to determining that a first process is to communicate with a second process.

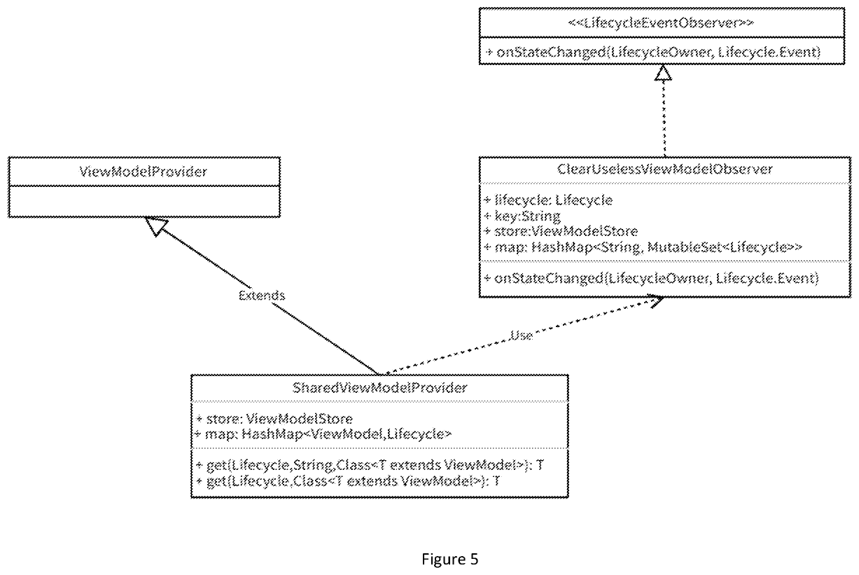

During specific implementation, as shown in FIG. 5, which is a UML class diagram of a code structure according to an embodiment of the present disclosure. First, a ClearUseless ViewModelObserver is customized and a LifecycleEventObserver interface is implemented. A Lifecycle object and a Map object are passed to the ClearUseless View ModelObserver, and then an onStateChanged method of the LifecycleEventObserver interface is implemented. When a parameter LifecycelEvent is Event. DESTROYED, this method removes a previous lifecycle from a corresponding value of the Map.

Then, a Store object and a Map object are passed to a Shared ViewModelProvider, and a get method is implemented, passing a parameter such as lifecycle and class into the method. A ViewModel is obtained and created by calling a super. get method of the ViewModelProvider.

The created ViewModel is put into the Store, the passed-in lifecycle is put into a value of the Map, a new ClearUseless ViewModelObserver object is created at the same time, and then an addObserver method of the Lifecycle is called to pass in the ClearUseless ViewModelObserver object.

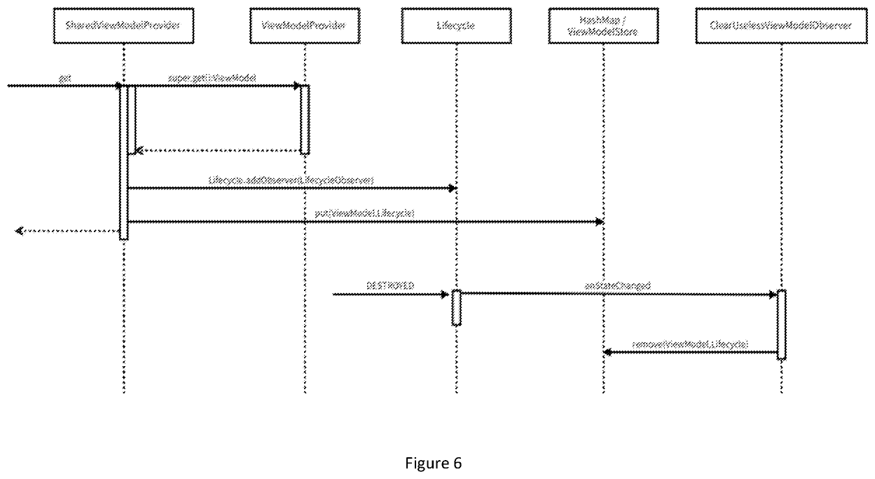

Through the above steps, the ViewModel object can be obtained by calling the get method of the Shared ViewModelProvider. The obtained ViewModel object will automatically sense the lifecycle of the passed-in Lifecycle object, and will be automatically destroyed when the lifecycle ends. The specific calling process described above is shown in FIG. 6.

Once the above preparations are completed, a process name of the first process and a process name of the second process are added to the Lifecycle.

S402: Cause the first process to communicate with the second process based on a two-way communication process.

During specific implementation, when it is detected that the Lifecycle contains the process name of the first process and the process name of the second process, the first process is caused to perform communication with the second process using ViewModel.

S403: Delete the identifier corresponding to either of the processes from the lifecycle table when it is determined that the process stops communicating.

During specific implementation, when the process stops communication using the ViewModel, the process name of the process is deleted from the Lifecycle. When content of a value in the Map is empty, ViewModel is removed from the Store.

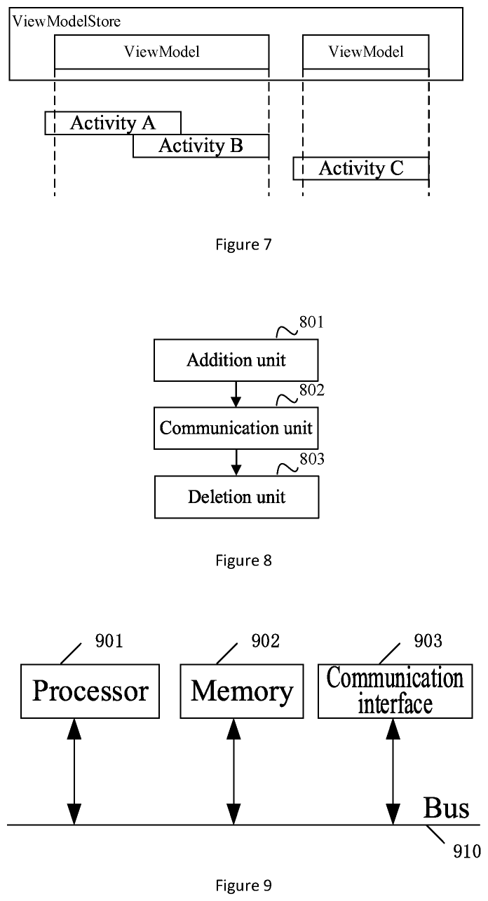

FIG. 7 is a schematic diagram of performing ViewModel communication using a shared space after the solution according to the embodiment of the present disclosure is applied. In this embodiment, a new ViewModelStore has been added to the SharedViewModel, a lifecycle of the ViewModelStore is no longer dependent on an Activity and a Fragment, but is consistent with a lifecycle of an Android application, that is, during runtime of the app, a same ViewModel instance can be obtained through the ViewModelStore. Then, the Shared ViewModel maintains a reference list in which a ViewModel instance and a Lifecycle instance that uses the ViewModel instance are recorded, and when a new Lifecycle uses the ViewModel, the Lifecycle instance is recorded in the list. The recorded Lifecycle instance is removed from the list when a lifecycle of the Lifecycle instance ends and reaches a DESTROYED state, and the ViewModel is released when all Lifecycle instances are removed from the list, improving the communication efficiency.

FIG. 8 is a two-way communication apparatus according to an embodiment of the present disclosure. The apparatus includes: an addition unit 801 configured to add an identifier corresponding to the first process and another identifier corresponding to the second process to a lifecycle table in response to determining that a first process is to communicate with a second process; a communication unit 802 configured to cause the first process to communicate with the second process based on a two-way communication process; and a deletion unit 803 configured to delete the identifier corresponding to either of the processes from the lifecycle table when it is determined that the process stops communicating.

In a possible implementation, in the apparatus provided in this embodiment of the present disclosure, the addition unit 801 is further configured to add an identifier corresponding to a third process to the lifecycle table when it is determined that the third process is to communicate with a target process corresponding to any one of identifiers in the lifecycle table; and the communication unit 802 is further configured to cause the third process to communicate with the target process based on the two-way communication process.

In a possible implementation, in the apparatus provided in this embodiment of the present disclosure, the communication unit 802 is further configured to stop the two-way communication process when there is no identifier corresponding to a process in the lifecycle table.

In a possible implementation, in the apparatus provided in this embodiment of the present disclosure, the deletion unit 803 is further configured to delete the two-way communication process and the lifecycle table.

In a possible implementation, in the apparatus provided in this embodiment of the present disclosure, the two-way communication process is generated within a shared region.

In addition, the two-way communication method and apparatus in the embodiments of the present disclosure described with reference to FIG. 1 to FIG. 8 may be implemented by an electronic device. FIG. 9 is a schematic diagram of a hardware structure of an electronic device according to an embodiment of the present disclosure.

The electronic device may include a processor 901 and a memory 902 storing computer program instructions.

Specifically, the processor 901 may include a central processing unit (CPU), an application-specific integrated circuit (ASIC), or one or more integrated circuits that may be configured to implement the embodiments of the present disclosure.

The memory 902 may include a mass memory for data or instructions. As an example rather than a limitation, the memory 902 may include a hard disk drive (HDD), a floppy disk drive, a flash memory, an optical disc, a magneto-optical disc, a magnetic tape, a universal serial bus (USB) drive, or a combination of two or more thereof. When appropriate, the memory 902 may include a removable or non-removable (or fixed) medium. When appropriate, the memory 902 may be internal or external to a data processing apparatus. In a particular embodiment, the memory 902 is a non-volatile solid state memory. In a particular embodiment, the memory 902 includes a read-only memory (ROM). When appropriate, the ROM may be a mask programmed ROM, a programmable ROM (PROM), an erasable PROM (EPROM), an electrically erasable PROM (EEPROM), an electrically alterable ROM (EAROM), a flash memory, or a combination of two or more thereof.

The processor 901 reads and executes the computer program instructions stored in the memory 902, to implement any of the methods for determining recommended information in the above embodiments.

In an example, the electronic device may further include a communication interface 903 and a bus 910. As shown in FIG. 9, the processor 901, the memory 902, and the communication interface 903 are connected through the bus 910 to communicate with each other.

The communication interface 903 is mainly configured to implement communication between the modules, apparatuses, units, and/or devices in the embodiments of the present disclosure.

The bus 910 includes hardware, software, or both, and couples components of the electronic device to each other. As an example rather than a limitation, the bus may include an Accelerated Graphics Port (AGP) or other graphics buses, an Extended Industry Standard Architecture (EISA) bus, a front-side bus (FSB), a HyperTransport (HT) interconnect bus, an Industry Standard Architecture (ISA) bus, an InfiniBand interconnect bus, a low pin count (LPC) bus, a memory bus, a Micro Channel architecture (MCA) bus, a Peripheral Component Interconnect (PCI) bus, a PCI-Express (PCI-X) bus, a Serial Advanced Technology Attachment (SATA) bus, a Video Electronics Standards Association Local Bus (VLB) or other suitable buses, or a combination of two or more thereof. When appropriate, the bus 910 may include one or more buses. Although the specific buses are described and illustrated in this embodiment of the present disclosure, any suitable bus or interconnect is contemplated in the present disclosure.

The electronic device may perform the two-way communication methods in the embodiments of the present disclosure based on a received service request sent by a smart device, thereby implementing the two-way communication methods and apparatus described with reference to FIG. 1 to FIG. 8.

In addition, an embodiment of the present disclosure may provide a computer-readable storage medium to implement the two-way communication methods in the above embodiments. The computer-readable storage medium has stored thereon computer program instructions that, when executed by a processor, cause any one of the two-way communication methods in the above embodiments to be implemented.

It should be noted that, herein, relative terms such as “first” and “second” are only used to distinguish one entity or operation from another entity or operation, and do not necessarily require or imply that such an actual relationship or order exists between these entities or operations. Moreover, the terms “include”, “comprise”, or any other variants thereof are intended to cover a non-exclusive inclusion, so that a process, a method, an article, or a device that includes a list of elements not only includes those elements but also includes other elements that are not listed, or further includes elements inherent to such a process, method, article, or device. In the absence of more restrictions, an element defined by “including a . . . ” does not exclude another same element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure is not limited to the embodiments described herein but is to be accorded the broadest scope consistent with the principle and novel features disclosed herein.

1. A two-way communication method, comprising:
adding an identifier corresponding to the first process and another identifier corresponding to the second process to a lifecycle table, in response to determining that a first process is to communicate with a second process;
causing the first process to communicate with the second process based on a two-way communication process; and
deleting the identifier corresponding to either of the processes from the lifecycle table when it is determined that the process stops communicating.

2. The method according to claim 1, further comprising:
adding an identifier corresponding to a third process to the lifecycle table when it is determined that the third process is to communicate with a target process corresponding to any one of identifiers in the lifecycle table; and
causing the third process to communicate with the target process based on the two-way communication process.

3. The method according to claim 1, further comprising:
stopping the two-way communication process when there is no identifier corresponding to a process in the lifecycle table.

4. The method according to claim 3, wherein after the two-way communication process is stopped, the method further comprises:
deleting the two-way communication process and the lifecycle table.

5. The method according to claim 1, wherein the two-way communication process is generated within a shared region.

6.-10. (canceled)

11. A two-way communication device, comprising:
a memory;
a processor; and
a computer program,
wherein the computer program is stored in the memory, and is configured to be executed by the processor to cause a method to be implemented, wherein the method comprises:
adding an identifier corresponding to the first process and another identifier corresponding to the second process to a lifecycle table, in response to determining that a first process is to communicate with a second process;
causing the first process to communicate with the second process based on a two-way communication process; and
deleting the identifier corresponding to either of the processes from the lifecycle table when it is determined that the process stops communicating.

12. A non-transitory computer-readable storage medium having a computer program stored thereon, wherein the computer program, when executed by a processor, causes a method, wherein the method comprises:
adding an identifier corresponding to the first process and another identifier corresponding to the second process to a lifecycle table, in response to determining that a first process is to communicate with a second process;
causing the first process to communicate with the second process based on a two-way communication process; and
deleting the identifier corresponding to either of the processes from the lifecycle table when it is determined that the process stops communicating.

13.-14. (canceled)

15. The two-way communication device according to claim 11, wherein the method further comprises:
adding an identifier corresponding to a third process to the lifecycle table when it is determined that the third process is to communicate with a target process corresponding to any one of identifiers in the lifecycle table; and
causing the third process to communicate with the target process based on the two-way communication process.

16. The two-way communication device according to claim 11, wherein the method further comprises:
stopping the two-way communication process when there is no identifier corresponding to a process in the lifecycle table.

17. The two-way communication device according to claim 16, wherein after the two-way communication process is stopped, the method further comprises:
deleting the two-way communication process and the lifecycle table.

18. The two-way communication device according to claim 11, wherein the two-way communication process is generated within a shared region.

19. The non-transitory computer-readable storage medium according to claim 12, wherein the method further comprises:
adding an identifier corresponding to a third process to the lifecycle table when it is determined that the third process is to communicate with a target process corresponding to any one of identifiers in the lifecycle table; and
causing the third process to communicate with the target process based on the two-way communication process.

20. The non-transitory computer-readable storage medium according to claim 12, wherein the method further comprises:
stopping the two-way communication process when there is no identifier corresponding to a process in the lifecycle table.

21. The non-transitory computer-readable storage medium according to claim 20, wherein after the two-way communication process is stopped, the method further comprises:
deleting the two-way communication process and the lifecycle table.

22. The non-transitory computer-readable storage medium according to claim 12, wherein the two-way communication process is generated within a shared region.
